(19) United States
(12) Patent Application Publication
(10) Pub. No.: US 2006/0179153 A1
(43) Pub. Date: Aug. 10, 2006

(54) Streaming based contents distribution network system and methods for splitting, merging and retrieving files

(76) Inventors: Nam-Yul Lee, Daejeon (KR); Kee-Joo Yoon, Seoul (KR)

Correspondence Address: DILWORTH & BARRESE, LLP, 333 EARLE OVINGTON BLVD., UNIONDALE, NY, 11553, US

(21) Appl. No.: 10/564,188

(22) PCT Filed: Mar. 22, 2004
(86) PCT No.: PCT/KR04/00623

§ 371 Date: Jan. 9, 2006

(51) Int. Cl. G06F 15/16

(52) U.S. Cl. 709/231

(57) ABSTRACT

A process for splitting, transforming and reproducing a multimedia file has the steps of uploading the file to an Admin Server after splitting or merging the file; synchronizing contents; selecting contents by a client's connection to a web server; performing authentication; downloading a desired file from the optimal contents server; saving the downloaded file as a temporary file form on a temporary file storage; reproducing the downloaded data (the contents) on a dedicated player; and deleting the temporary file with the completion of the reproduction.

### TECHNICAL FIELD

This invention relates to a streaming-based contents distribution network system. More specifically speaking, this invention relates to a technology that splits contents into a number of small capacity files and transmits them in order to safely download large capacity multimedia contents including moving picture data so that a user can download a large capacity contents safely and as a result he/she can reproduce multimedia data in high quality while downloading files.

### BACKGROUND TECHNOLOGY

In transmitting and receiving a large capacity of multimedia contents files like voice files, picture files, moving picture files and animation files on Internet, a prior art has used a method in which at first a corresponding file was downloaded into a hard disk and then was reproduced. However the method was inconvenient, for it took a long time in case of downloading a large capacity file like multimedia contents. And also it has a problem that when generally a file is reproduced, the connection is disconnected frequently because of small buffer size and so in this case the file should be downloaded again from the beginning.

FIG. 20 shows a concept of a prior art streaming service. A contents provider server (CP Server) (10) provides contents to a user (20) through a number of Internet service providers (called ‘Edge’ too) (40) that are connected to each other. That is, in the existing streaming service users physically passed through a plurality of ISPs (40) in order to connect to a contents provider server (CP Server) (10).

The existing streaming methods have problems that in a server-client structure, when a central management server transmits contents to a plurality of clients, server load may be increase and it is hardly to provide high quality of multimedia streaming service due to a bottleneck phenomenon of a network bandwidth.

And since according to the clients' requests of multimedia files the existing streaming methods download the entire contents files through only one open session, the methods increase server load if there are a number of clients.

Moreover in reproducing them by using a client multimedia player, because contents buffering starts from a server to a local client PC, the whole file should be re-transmitted and it is impossible to reproduce it from a desired part.

The existing streaming service has defects like low quality of multimedia streaming service, high cost for storage, demand of large bandwidth etc. And besides, if data-receiving speed is not high enough, a problem that data does not flow smoothly like a picture disconnection phenomenon may occur. Therefore there are problems that it is difficult to manage the rapidly changing traffic if it has low capacity compared with an investing cost and a bottleneck phenomenon like an Internet Middle-Mile, an instant connection increase, and a domino phenomenon of concentration and obstacle of traffic and server load occur.

An SCDN always has to be able to perform a Global ITM (Internet Traffic Management) on the basis of accurate information for network distance regardless of setting up a user's DNS (Domain Name Server). And it has to be able to perform an accurate Local ITM on the basis of more detailed Health Check for a server regardless of an Edge server's kind and installation environment. For example it is necessary to check CPU, Memory, session number for each port and the like of a server carefully.

On the one hand, to cope with the instantaneous traffic congestion by the increase of the amount of instantaneous connection requests, a Stand-aside type ITM solution that can simplify network structure of each Edge is advantageous. In case that an ITM solution operates depending on a DNS, the quality of service falls off and a manager can hardly cope with severe obstacles that may occur suddenly. Therefore a solution independent of a DNS is needed.

In order to solve the problems of continuously increasing traffic and Edge server load, constructing a network as a pyramid shape brings about higher costs inevitably. Therefore a new type of an ITM solution that can solve the above problems is needed. And also is needed a technology that is capable of distributing and synchronizing contents to each other efficiently in case that a number of Origin servers and Edge servers are dispersed on Internet.

And the existing Streaming Service is not coping with the change of a user actively. That is, previously a condition of 320×240 and 100˜300 Kbps was satisfactory as services but at present a condition of 512×384 and more than 1 Mbps (DVD level) is needed and yet countermeasures are not sufficient. And the existing method doesn't adopt an active-type downloading method.

### BRIEF DESCRIPTION OF THE DRAWINGS

FIG. 1 is a structural view of an SCDN (Streaming Contents Distribution Network) system according to a preferred embodiment of the present invention.

FIGS. 2, 3, 4 and 5 are flow charts of a preferred embodiment of an operating method of an SCDN system according to the present invention.

FIGS. 6, 7, 8 and 9 are block diagrams of a system for splitting a file, merging files and reproducing media for an SCDN system according to the present invention.

FIGS. 10, 11, 12 and 13 illustrate preferred embodiments of a splitting process for a contents file according to the present invention.

FIG. 14 is an exemplary view of a method for using service according to the present invention.

FIG. 15 is an exemplary view of structure of an SCDN (Streaming Contents Distribution Network) according to the present invention.

FIG. 16 is an exemplary view of a Stand-aside type ITM solution according to the present invention.

FIG. 17 is a structural view of a header file according to the present invention.

FIGS. 18 and 19 are flowcharts of an authentication process according to the present invention.

FIG. 20 is a concept view of a prior art of a streaming service.

### DETAILED DESCRIPTION OF THE INVENTION

Technical Subject

1. A structure of an SCDN System

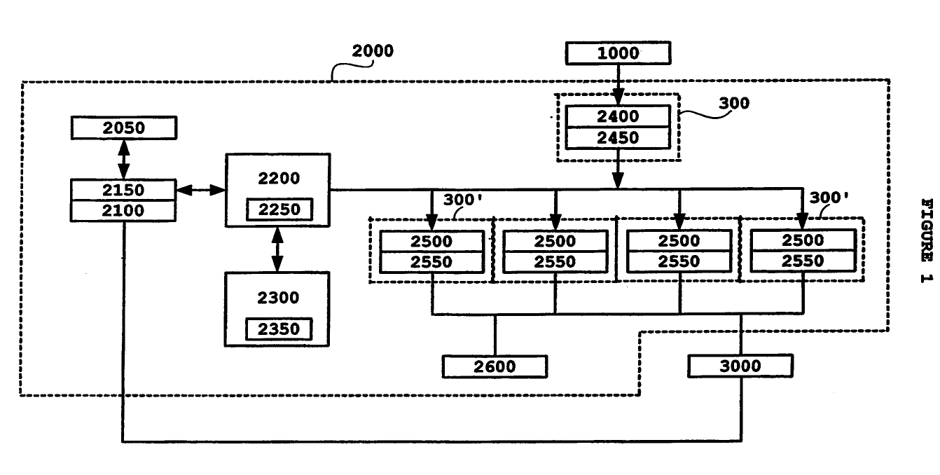

FIG. 1 shows a structure of an SCDN (Streaming Contents Distribution Network) system according to a preferred embodiment of the present invention. The service forms provided by this invention are as follows:

The first, one of the service forms that this invention can provide is a Streaming Service. UI (User Interface) functions like a Seek function and a time restrict function by an Interactive Player are provided. This service can be applied to Contents provision for education and to other various forms.

The second, other service form provided by this invention is a Download Service. This service saves split files in a Client and restricts the number of reproducing times and reproducing time.

The third, the other service forms provided by this invention are Global Load Balancing, Server Load Balancing (IPMaster is in charge of it), Contents Distribution (CDMaster is in charge of it) and non-stop service. The non-stop service is to make progress the process continuously by connecting to other servers automatically when some of Contents Servers do not operate. And this service supports various formats. For example it supports MPEG1, AVI and ASF series (WMT). And because its structure is independent of Codec's, it is not necessary to consider Upgrade per Codec to occur in the future. Moreover, since it uses an Interactive Playing method, a real time Seek for the already watched parts is possible without buffering.

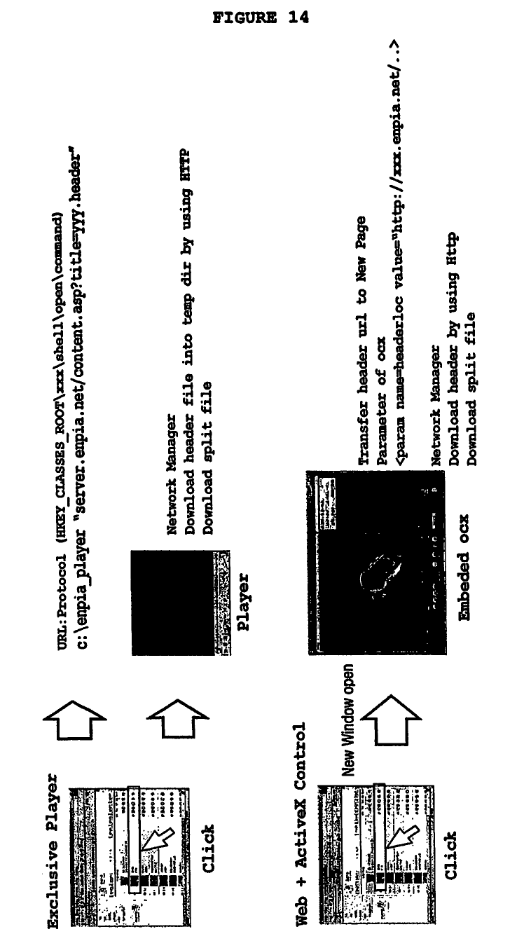

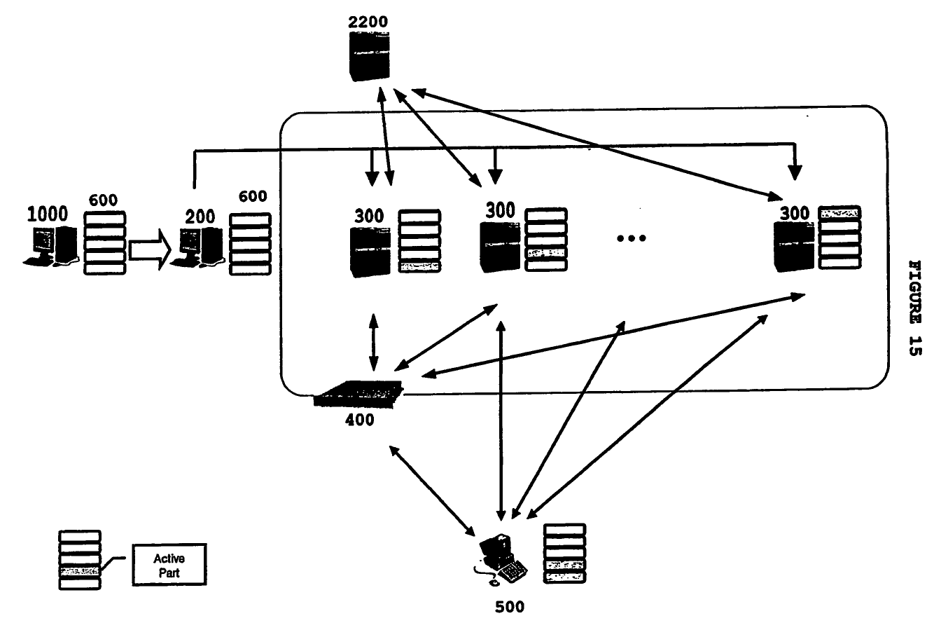

FIG. 14 is an exemplary view of a method for service usage according to the present invention. The upper part of the figure shows a picture using a dedicated player and the lower part of the figure shows a picture using a player that Web and ActiveX Control are combined. In this invention, if the dedicated player is used, a network manager downloads a header file into a temp directory by using a HTTP and downloads split contents files into a predetermined folder of Windows System. But, if the player that Web and ActiveX Control are combined is used, it opens a new Window page and transmits a header URL to the new page. Then the network manager downloads the header file and the split contents files into a predetermined folder of Windows System by using HTTP.

Now the structure of a system according to the present invention is described more clearly. The system of this invention aims at realizing Multimedia File Playing through a Network. For this, the system of this invention comprises an Admin Client, an Admin Server including a CMS Server, a Contents Web Server including an Authentication Server for users, an Authentication Proxy Server, a Primary Authentication Gateway Server, a Secondary Authentication Gateway Server, a Contents Server including a plurality of CASes and an SM Agent, and an Enpia Player for file reproducing. Furthermore the system of this invention comprises a DRM (Digital Rights Management) solution for protection of contents, an IPMaster for realizing Internet Traffic Management, and a CDMaster for realizing synchronization of contents file.

1-1. An Admin Client

An Admin Client splits a large capacity of multimedia contents by using a Split function of an Enpia Splitter program and then creates a number of files (600) and a Header file.

That is, it provides a function that splits a multimedia file into object files having a desired capacity and saves them.

Further it restores multimedia files that were split by a Splitter using a Merge function of the Enpia Splitter program, to the original state.

The Admin Client provides a simple GUI (Graphic User Interface) based on Windows and makes it possible to check the process for implementing a Split/Merge function and its result.

DRM (Digital Rights Management) is applied to the split multimedia files. It has an encrypt function for each split file in order to protect the information of each split file. The DRM function can be applied partially according to a Protect Policy of Multimedia Files when it is needed.

1-2. An Admin Server

An Admin Server briefly provides an addition/deletion function of a user session, a user session list function, a validity inspection function about a user session request required by an authentication proxy server, a modification function of a configuration file by an authentication Gateway server, a save and management function of connection records log about contents transmitted from a contents server, a real time monitoring function and a statistics function and the like.

A real time data monitoring function of a CMS server (200) detects data creation, modification and deletion like deleting or uploading data from an Admin Client in real time.

Each split file whose creation, modification or deletion has been monitored is transmitted to a Contents Server including its own CAS server Module respectively.

A CMS server performs the synchronization with an original contents file.

1-3. An Authentication Proxy Server.

It provides a response function to an authentication Key request of a user Authentication Server. It shares authenticate information, authenticate ID, contents, completion time of contents, and an authentication key with a Primary Authentication Gateway Server.

1-4. A Primary Authentication Gateway Server and a Secondary Authentication Gateway Server

A Primary Authentication Gateway Server or a Secondary Authentication Gateway Server has an authority to be able to permit approaching to the contents saved on each contents server and therefore it performs User Authentication.

1-5. A Contents Server

A Contents Server plays a role of a file server having contents. It comprises largely a CAS Server (300) and an SM Agent server. As a contents server distributing and saving split original contents file and a Header File, a CAS Server (300) performs a function of contents synchronization. Each CAS Server (300) copies the files that were split by a CMS (200) and saves them on a database (320). The database (320) has a UUID (Universal Unique Identifier) File List (322). The Contents of each contents server are synchronized in real-time. Therefore even if a fault occurs in any one of a plurality of CAS servers (300), other CAS servers (300) can provide the same contents. And so this system according to the present invention is more excellent in fault tolerance than the prior arts.

A CAS server (300) transmits split contents files and a Header File in a folder designated by a manager to other CAS Servers (300) in accordance with the command of the CMS server, or receives data from other CAS servers (300).

An SM Agent performs a monitoring function of a Contents server in real time.

The SM Agent (Server Monitoring Agents) collects the information of CPU, Memory and Session of a Contents Server at an interval of predetermined time and provides it as Server load balancing information.

1-6. An IPMaster

An IPMaster Server receives the information of CPU, Memory, Session of a Contents Server at an interval of predetermined time from an SM Agent installed in each Contents Server in real time. The collected server information is a requirement that lets a client select the optimal contents server among servers saving split contents files.

When an authenticated client (500) requests, an IPMaster (400) selects the optimal Contents Server (300) for a corresponding client (500) and lets the client receive desired contents (600) from a corresponding Contents Server (300) by using its function for monitoring the information of CPU, Memory and Session of the Contents Server (300) in real time.

1-7. A Client/Player

If the authentication of contents is completed normally, a Client/Player (500) downloads a Header File into a Database (510) and parses it and takes charge of scheduling for download. And in the Database (510) there are a UUID File List (514) having a split file list and a Temp List (516) having reproduction data information.

And in the Client/Player (500) there are a manager of local files and a DRM decoder (518).

The Client/Player (500) can download split files in parallel by a number of Threads. The Client/Player (500) is based on MS Window series OS being capable of multi-tasking. So it can download the split files in parallel and therefore the system is more stable, can reproduce and download the files in high speed. In this case the Client/Player (500) reproduces a file by reading the configuration information of split files recorded in the Header File. Since the reproducing order is determined by prescribed scheduling information, there is no matter especially in reproduction.

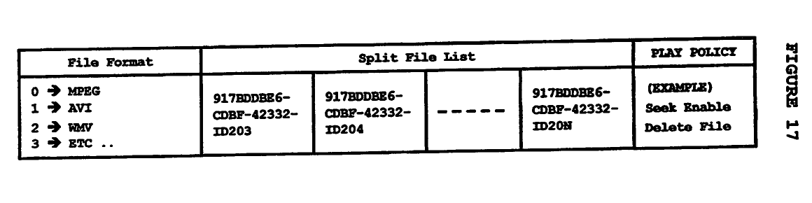

The Client/Player (500) reproduces a plurality of split files that have been downloaded by using a manager of local files and a DRM decoder (518) as if the files are in one HDD. For this, header information of a header file as shown in the FIG. 17 is used. And at the same time with the reproduction, it downloads the files that will be reproduced next time from a CAS server (300). Therefore a file can be reproduced continuously and it has a high quality of reproduction. In addition, as the split files have small sizes, although a buffer has a small capacity, there is no matter especially in buffering. Moreover the Client/Player (500) decodes the encoded files by using a DRM. A player used in this invention is the dedicated player for this invention.

2. Operation of an SCDN System

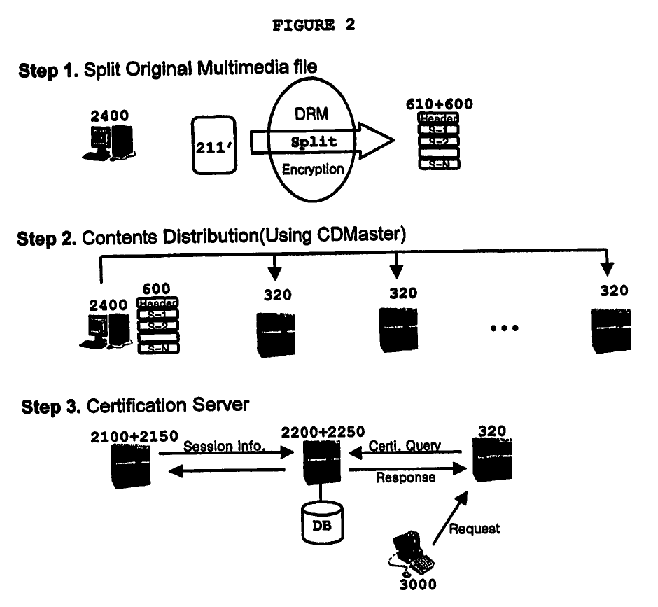

The flow charts of preferred embodiments for an operating method of an SCDN system according to the present invention are shown in from FIG. 2 to FIG. 5. The FIG. 2 shows the processes of a server side by dividing them into three steps large.

In the first step, an original multimedia file of an Admin Client is split into certain sizes of files by a file Splitter. As a result of it, the files split into certain sizes and a header file including the split information are created. Contents may be encoded under the necessity of protection by using a DRM technology. The encoded contents are decoded when they are reproduced on a Client Player.

In the second step, contents are synchronized through a CDMaster solution. That is, by using a function for monitoring a file in real time of a CMS server placed in an Admin server, a Contents server including a plurality of CAS servers synchronizes Header Files and Split Files, which are created, modified and deleted.

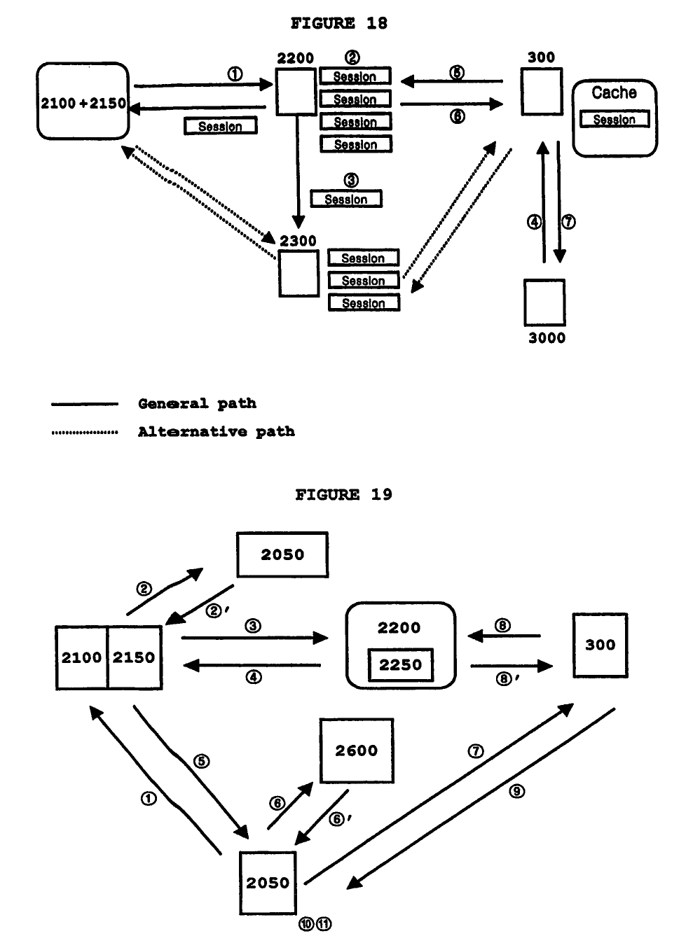

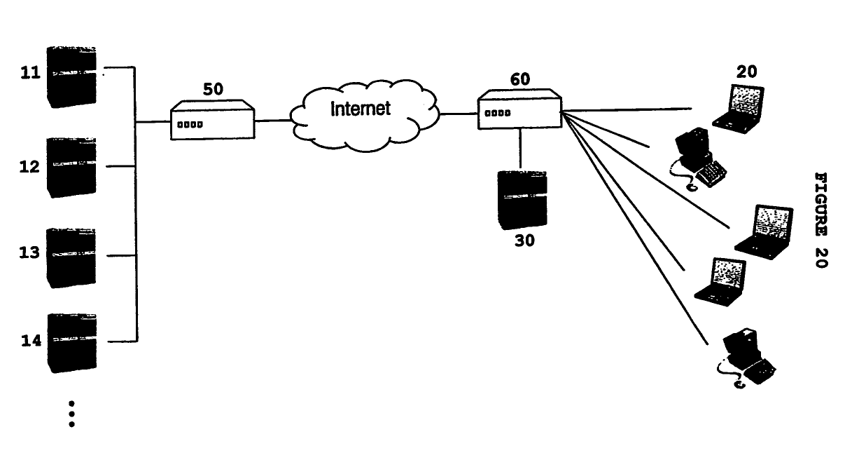

In the third step, the Authentication Gateway Server is in charge of the authentication about a user. A detailed authentication process is shown in FIGS. 18 and 19. Clients request the authentication about an authentication Key downloaded from an authentication server of a user side and a Primary Authentication Gateway server having the authenticate information judges whether it will authenticate the requested authentication or not.

An Authentication Server performing a real authentication process comprises an Authentication Proxy server and a Primary authentication Gateway server, and when a failure in Primary Authentication Gateway Server occurs, a Secondary Authentication Gateway Server located at an automatic alternative routing performs an authentication.

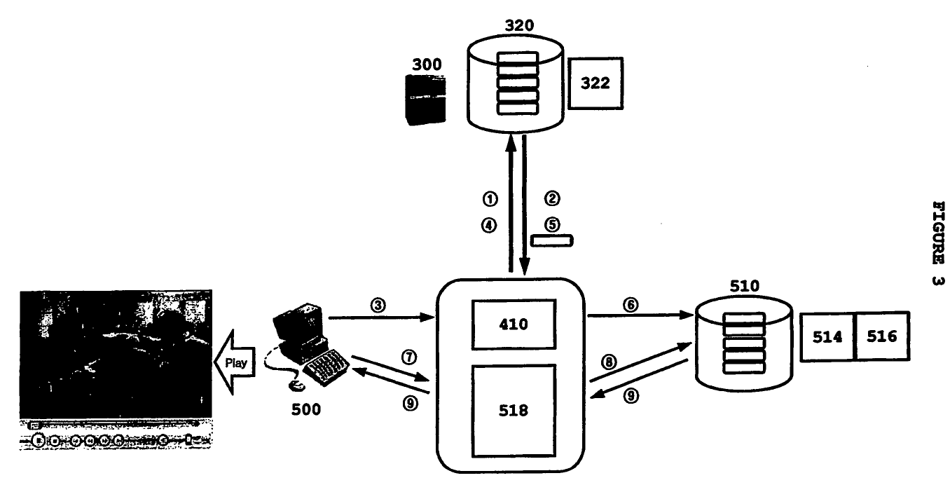

FIG. 3 shows a reproduction process of a contents file performed in a customer side. A Client/Player (500) comprises a Network Manager, a Local File Manager and a DRM Decryption Manager (518).

The Client/Player (500) requests data needed for reproducing contents to a Contents server. According to the request, by making a reference to a UUID List (322), the Contents server searches a corresponding file saved on a database (320) and provides a Header File to a Network Manager (410). If the Header File is transferred to the Client/Player (500), the Client/Player (500) parses it and then transmits the parsing result to the network manager (410). According to this, if the Network Manager (410) requests a file to a Contents server (300), the Contents server transmits the corresponding file to the Network Manager (410). The Network Manager (410) saves this file on a database (510) and if the Client/Player (500) requests the data, the Local File Manager and the DRM Decryption Manager (518) open the corresponding file from the database (510) and transmit it to the Client/Player (500) and then the Client/Player reproduces it.

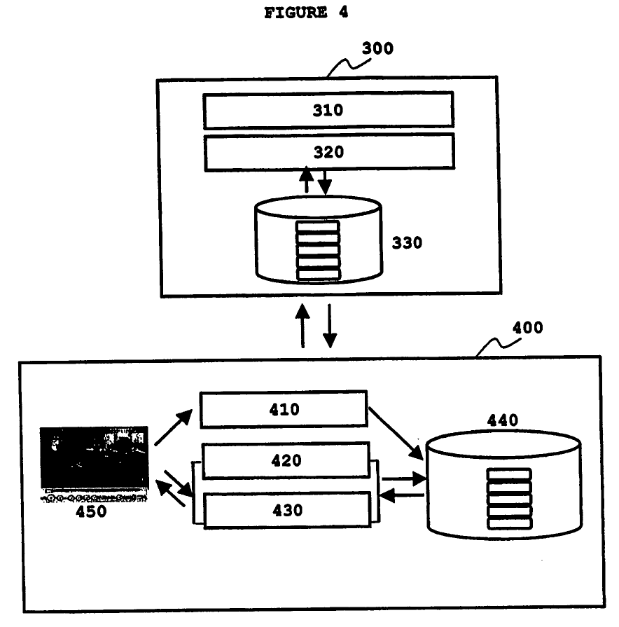

FIG. 4 shows an example of a service process according to the present invention. The service process comprises a step for requesting contents for reproduction by a Client/Player (500), a step for performing authentication, a step for downloading a Header File and an authentication Key if the authentication is completed normally, a step for requesting contents query to an IPMaster server for the sake of selecting the optimal contents server, a step for checking whether authenticated or not by an Authentication Gateway Server, a step for downloading a schedule and contents and a step for reproducing the contents by an Enpia Player.

FIG. 5 shows a detailed example of a service process according to the present invention. The Client/Player (500) is connected to a Web server and selects contents. The Authentication Server of a user side performs authentication for a user ID, contents, the completion time of contents and the like, and then requests a billing process about an authenticated user to a billing system server. The Authentication Server of a user side requests the authenticate information to an Authentication Proxy server. The Authentication Proxy server transmits the authenticate information to the Authentication Server of a user side. After completion of authentication the user-side Authentication Server downloads an authentication Key about contents and a Header File into the Client/Player (500). If the Client/Player (500) received the authentication Key requests contents to an IPMaster (400)\textcircled{1}, then the IPMaster (400) appoints a contents server and the Client/Player (500) requests contents files to the appointed contents server with the authentication Key. And then the contents server requests verification to the Primary Authentication Gateway Server (100) whether the Key is authenticated or not, and if it is authenticated, then a schedule and contents files axe downloaded. And a Player (500) reproduces the data \textcircled{5}. At this time a management module saves the authentication Key and the downloaded data on a storage appointed by a user and deletes temporary files when the reproduction is completed.

3. A System for Splitting a File, Merging Files and Reproducing Media for an SCDN System

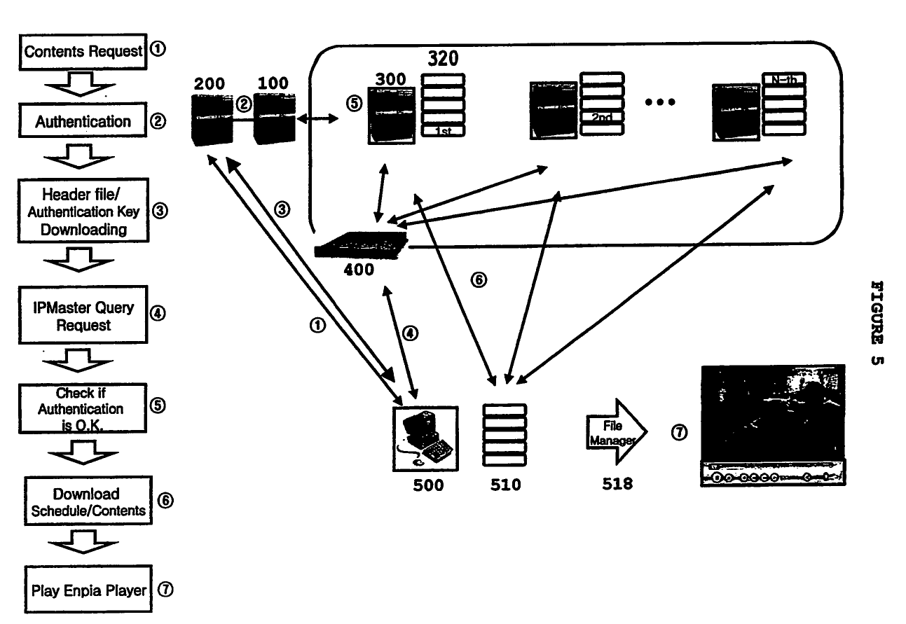

FIG. 6 to FIG. 9 show block diagrams of a system for splitting a file, merging files and reproducing media for an SCDN system according to the present invention. As shown in FIG. 6, the main components of this system are an ENSplitter (210), an ENNetwork (230), and an ENSource (310). Each of them has the following function.

3-1. An ENSplitter

An ENSplitter (210) splits an original multimedia file of a contents server into a plurality of UUID files (620) and creates a Header fi le saving connecting information for the split file. The Header file uses a type of data called as UUID (Universally unique identifier) used in a Microsoft based operating system.

This data has a type of 6B29FC40-CA47-1067-B31D-00DD010662DA and duplicate data cannot be created.

In this case the reasons of using ‘UUID’ as a split file name are as follows. Firstly, there is no possibility for other split file names to be used repeatedly. Secondly, although the split files are open to the public, it is impossible for them to re-merge the split files since their order is indistinguishable. And when a contents provider wishes to restore original multimedia file, it performs a file merging. It creates and analyzes a Header File (610) and encrypts/decrypts UUID files (620) with the interlocking of an IENSource interface of an ENSource (310)

3-2. An ENNetwork

An ENNetwork (230) downloads a plurality of UUID files (620) saved on a database (220) in each contents server into a database (510) of a Client (500) side, and then saves them on a Hard Disk of a client as a form of Temporary Files (512) and manages them. And at the same time if an ENSource (310) requests a certain UUID file (620), then the ENNetwork downloads the corresponding file or searches it and transmits the file handle (a Header file) to the ENSource (310). And the ENNetwork (230) has a table (232) saving the lists of UUID files (620) and their corresponding lists of Temporary files (512).

3-3. An ENSource

An ENSource (310) participates in both of the process of file split/mergence and the process of media reproduction, and operates differently in each process. The ENSource (310) really splits/merges media files and creates/analyzes their corresponding Header files (610) and at this time it encrypts/decrypts the UUID files (620). Moreover the ENSource (310) operates as a regular Direct Show Source Filter and transmits the media data according to the data requests of a Filter Graph (520), in addition it operates as a source plug-in DDL when a Window media file is reproduced. The ENSource (310) has UUID files (620) and a table (312) having information for the positions and capacities of the files.

3-4. An ENPlayer

An ENPlayer not shown in FIG. 6 is a Direct Show Application and plays a role as a real Filter Graph (520). The ENPlayer requests data with clear description for its position and capacity to an ENSource (310) through a Filter Graph Manager, and processes the transmitted data and reproduces media. In addition to the ENPlayer, every Direct Show Application like Window media player control can reproduce media through the present system. The Filter Graph (520) is placed in an ENPlayer and has a play function of moving pictures.

3-5. A File Split Method

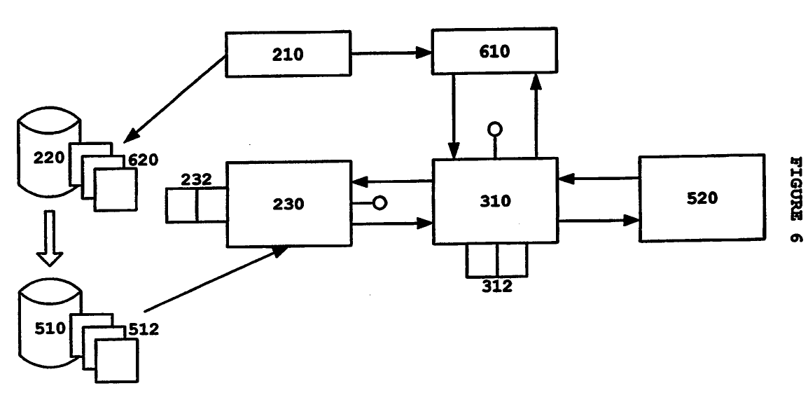

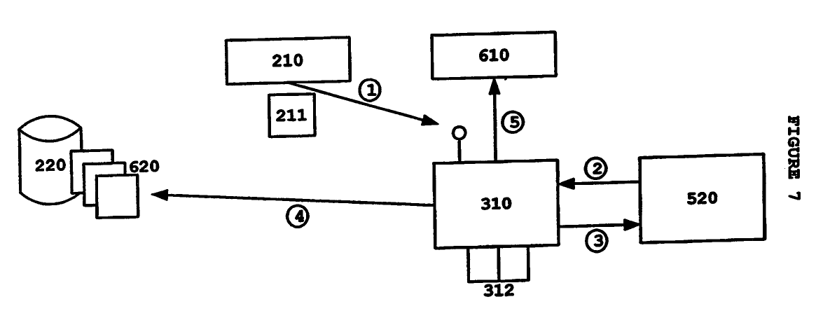

As shown in FIG. 7 an ENSplitter (210) plays a role as a main starting point in splitting a media file. The file split process according to the present invention is as follows: the ENSplitter (210) transmits a path of a source file (211) through an IENSource interface of an ENSource (310). The ENSplitter (210) lets a Filter Graph Manager operate so that the ENSource (310) participates in connecting a Filter Graph (520). In this process a Parser Filter (not shown in figure) requests data to an ENSource (310). The ENSource (310) transmits the requested data saved on a Filter Graph (520) and records the particulars. If the ENSplitter (210) gives a split order through an IENSource interface, the ENSource (310) splits a media file based on the information of connection and split capacity. UUID files (620) needed in splitting are allotted dynamically. And in this case an encryption process can be included. After completion of the file splitting the ENSource (310) arranges UUID files (620) and their tables (312) for position and capacity, and then creates a Header file (610).

<A Preferred Embodiment of a File Splitting>

An ENSplitter (210) has a source file, an object file, a capacity of a file to be split, means of function selection, means of format selection and a Window. The means of function selection has a split button and a mergence button, and a means of format selection has an AVI button, an MPEG button and a Window Media button. In the means of function selection of this invention the split button is selected basically. A source file can be selected here.

On the other hand if a source file is appointed, a path of an object file is appointed automatically as a changed Extension form of ‘*.enp’. It can be changed if necessary. The split capacity can be appointed by a manager arbitrarily in the consideration of the whole capacity of a multimedia file and the efficiency of a CMS server and a CAS server.

The next task to do is to appoint a format of a source file in the means of format selection. If a file splitter detects an incorrect appointment of a file format by the analysis of properties of a multimedia file, it outputs a Rendering error message like ‘The file format is incorrect’. If we appoint a file format correctly and push a start button, then the file split process is executed. If a message ‘A Header file was copied’ is displayed on a screen, it represents that the file split was completed normally.

A File splitter splits a multimedia file to a plurality of files whose file sizes are appointed and creates the information of a Header file. The data of a Text Area appeared after the file split is connection information needed when the corresponding source files construct a filter graph (520). Because only after the construction of the filter graph (520), it is possible to discriminate whether it is to be reproduced or not, this information plays a role as important primary data in splitting files. In (x, y), x and y imply position data in a file, namely header information, respectively. A starting point is 0. FIG. 10 shows a preferred embodiment of an information analysis in splitting of a contents file according to the present invention.

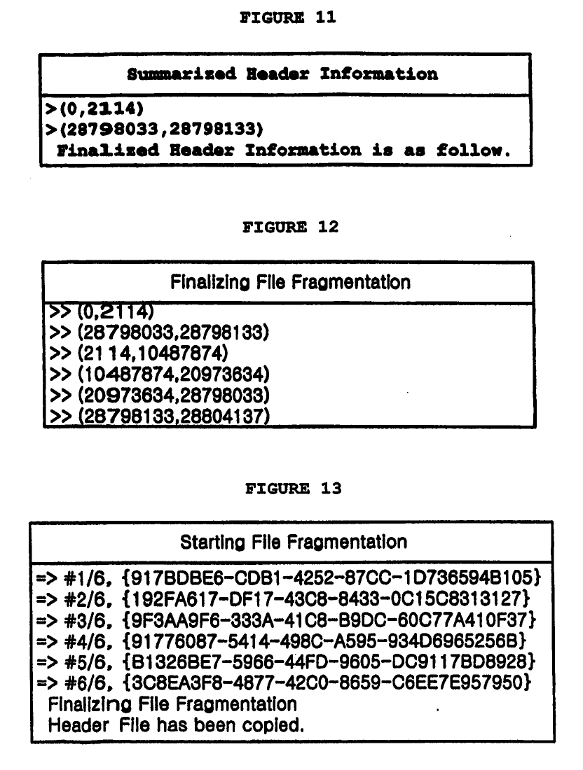

And in a file split process base d on connection information, a plurality of small file parts are created and accordingly a process to arrange them is needed. If the information to be connected with each other is arranged, it can be simplified to two files like a (0, 2114) file and a (28798033, 28798133) file as shown in FIG. 11.

And the file information to be split finally according to an appointed split size is shown with arranged connection information. In this case, because the connection information is important, the connection information like 2114, 10487874, 20973634, 28798133 is put at the top of Header information. And the rest data is split like 10487874, 20973634, 28798033, 28804137 to be a size of 10 MB for each file according to an appointed split size (213) for preventing from duplication to each other. FIG. 12 shows the final split information.

FIG. 13 shows a process of splitting an actual file and copying a Header file based on analyzed information. The name of a split file appears as a form of a GUID (Globally Unique Identifier) as shown in the figure.

In here the Extension (at present: *.enp), which is appointed basically in an ENSplitter, has no any further means above an Extension. Therefore if we want to change a basic Extension, what is necessary is only to change the EXTENSION defined at a header file ‘ENSplitterDlg.h’. And because a function of OnFileOpen( ) has a function to add a parser filter in accordance with a format, if a supported format is added, it has to be added to it too: Because it is necessary to format verification and improvement of efficiency.

On the other hand, in use of a Window media format, a protocol appointed at an ENSource (310) is used. Therefore if a format is changed, the protocol also has to be changed. And care should be given to a fact that a WM (Windows Media) Reader as a filter to use a Window media format SDK (Software Development Kit) provides a Reader object and provides a source plug-in normally from version above 9.0, and in this case it is installed with Window media player 9.0 together. In order to support a new version of Window media file, a new DLL has to be obtained through a format SDK of a Windows Media Technology 9.0. In addition if we wish to use a Window media format of Microsoft, a predetermined license contract has to be made but it has nothing to do with this invention.

3-6. A Method for Merging Files

In restoring multimedia files split by a File splitter into an original file, Merge function of an ENSplitter is used. Explaining with reference to FIG. 8 about a method for merging files, an ENSplitter (210) operates as a Merger and becomes a start point of a file merging process in case of merging UUID files. The File merging processes according to the present invention are as follows: An ENSplitter (210) transmits a Header file (610) path to an ENSource through an IENSource interface of an ENSource (310). The ENSource (310) analyzes the Header file (610) and restores UUID files (620) and their tables for position and capacity. The ENSource (310) requests a UUID file (620) through an IENManager interface of an ENNetwork (230) in accordance with the information recorded in a Header file (610). The ENNetwork (230) copies or downloads the UUID file (620) which the ENSource (310) requested and saves it on a temporary storage (510) and transmits the corresponding file handle to the ENSource (310). The ENSource (310) reads data through a file handle transmitted from the ENNetwork (230) and performs file merging and restores an original file (630). If a file is encrypted, a merging process is performed after decrypting it.

<A Preferred Embodiment of File Mergence>

Now we describe a preferred embodiment of file mergence. This function is in order to verify whether split files are restored as they were. If ‘Mergence’ is selected among Means of function selection, an ENSplitter (210) performs merging. And then a header file whose Extension is *.enp, is appointed at a source file. Then it analyzes the appointed format of the source file and displays it on a Window screen. At the same time, a format in Means of format selection is decided automatically. Therefore in the process of file mergence it is needless to appoint a format.

If a source file is a file header that cannot be detected, an error message of ‘The file cannot be detected’ appears.

The file merging process is executed by pushing a ‘start button’ and appearance of a message ‘File merging was completed’ implies normal completion of a merging process.

3-7. A Method for Reproducing Media

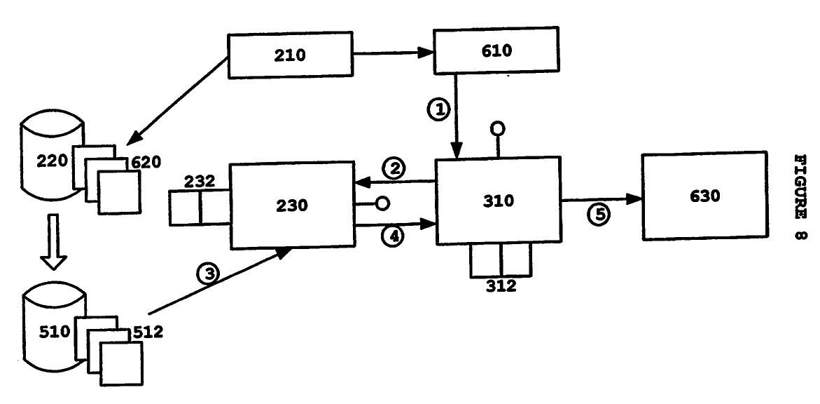

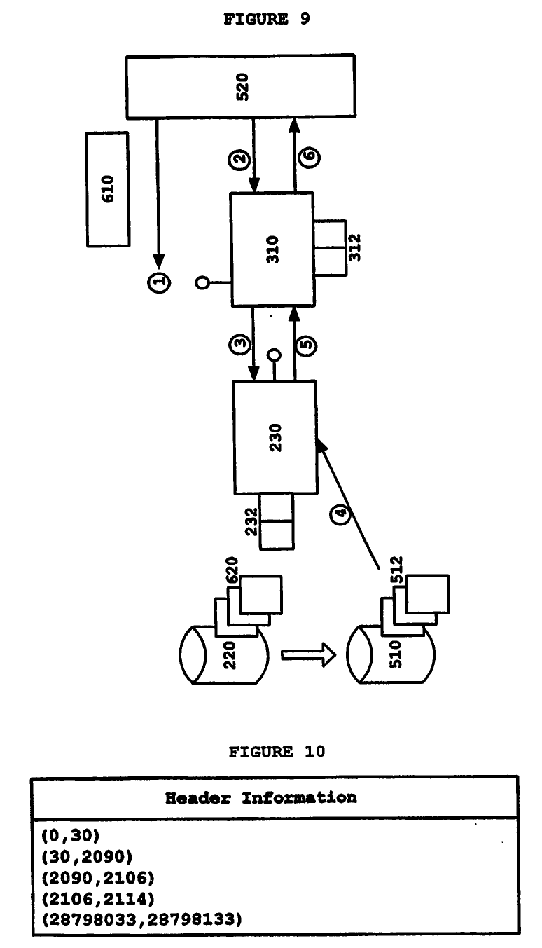

In case of reproducing media, explaining with reference to FIG. 9, a Direct show application is a main starting point. Therefore in the position of this system the operation according to the request of a filter graph (520) starts. Media reproduction processes according to the present invention are as follows: A Header file path appointed by a Direct show application is transmitted to an IfileSourceFillter interface of an ENSource (310) through a filter graph manager. The ENSource (310) analyzes a Header file (610) and restores UUID files (620) and their tables for position and capacity. The Filter graph (520) requests the data, which is needed to the connection and reproduction, to the ENSource (310) in sequence. In transmitting it describes the data position and capacity clearly. For the data requested by a filter graph (520), the ENSource (310) searches UUID files (620) in accordance with the information recorded in a Header file (610) and requests the file through an IENManager interface of an ENNetwork (230). The ENNetwork (230) copies or downloads the UUID files (620) that the ENSource (310) requested and saves them on a temporary storage (510) and transmits the file handle to the ENSource (310). The ENSource (310) reads data through the file handle transmitted from the ENNetwork (230) and transmits them to a Filter graph (520). If a file is encrypted, a decryption process is to do.

3-8. A Method for Scheduling (Downloading) Media

Multimedia files that were split by a File Splitter can be divided into two parts: One is a media header part file list having connection information needed in reproduction and the other is a data part file list having information of pictures and sound that are being reproduced.

A Client/Player (500) analyzes a downloaded header file and starts to download a necessary file list.

In program execution, it starts to download a media header part needed in reproduction and the program is blocked during the downloading. At this time a plurality of files are downloaded simultaneously by using a plurality of threads and if there is a file having a larger capacity compared to a user's appointment, it is divided into a plurality of threads again and the files are downloaded quickly and merged. These processes are repeated.

If the downloading process of a media-header is completed, a program reconstructs the information of the media-header and downloads a data part file. It receives a plurality of data files simultaneously by using suitable number of sockets, and then the program gets activated and starts to reproduce data files.

In this case for continuous and quick data saving, a plurality of data files is downloaded simultaneously by using suitable number of sockets (threads). A downloading process of the previous files is completed after completing a necessary task for downloading a file list that will be necessary later in advance by using header information. Then a downloading process of prepared files is performed. These processes are repeated.

In case that a reproduction part was moved (seek function), it waits the completion of a previous work that was being downloaded. And a necessary part of a file list is sought by analyzing the position value of the moved part. And then it starts to download and reproduce the file from the necessary part of a file simultaneously by using suitable number of threads.

And basically contents can be downloaded through five sockets (one socket per thread). Simultaneous socket number can be calculated by the consideration of a user's network state. If the user's network state is slow not enough to reproduce contents, it can be set up by using a function like ‘reserve view’ so that the contents can be reproduced after the completion of downloading a predefined file list.

In this case a point of time for reproduction is calculated by the consideration of reproduction time and downloading time of a whole file.

### ADVANTAGEOUS EFFECTS

The expected effects from the above present invention are as follows. A high speed streaming technique according to the present invention can be applied to a Business Video on Demand that rises as a main issue of business competitiveness.

The present invention can be applied to a high speed streaming technique and can solve a bottleneck phenomenon of an Internet Middle-Mile. And it can cope with an instantaneous connection increase, a domino phenomenon of a server load, a domino phenomenon of congestion and obstacle of traffic quickly.

In addition it is easy to manage rapidly changing traffic by executing this invention. And it can solve the ROI (Rate of Investment) problem of a streaming service because this invention provides a multicasting technology in which 1:N transmission is possible. FIG. 15 is an exemplary view of a structure of an SCDN (Streaming Contents Distribution Network) according to the present invention. A Business user (800) and a private user (900) can use multimedia data, which an Original media server palm (700) provides. The Business user (800) receives data directly from the Original media server palm (700) through LAN and the private user (900) receives data through an Edge Media (1000) of an ISP. The SCDN of FIG. 15 can solve the previous ROI (Rate of Investment) problem.

According to this invention, construction cost of equipment, network cost, and labor cost can be reduced above 11% at least and new business chances can be made. That is, a hardware cost can be reduced because if infra for transmitting data is built once, nothing is needed any more, and a management cost can be reduced because of a distributed system management through central and remote management, and a bandwidth cost can be reduced because of an integrated contents networking system.

By The present invention, flexibility of management, Centralized management, and Centralized monitoring can be performed. It has excellent functions for Global load balancing, Local server load balancing, and network architecture in a point of view of performance. Accordingly it is possible to perform always a Global ITM based on accurate information for network distance by an SCDN of this invention regardless of a user's setting for a DNS. That is, Accurate Proximity is obtained. And regardless of types of Edge servers and install environment we can perform an accurate local ITM through checking deep server health like hardware load, process health, and contents health.

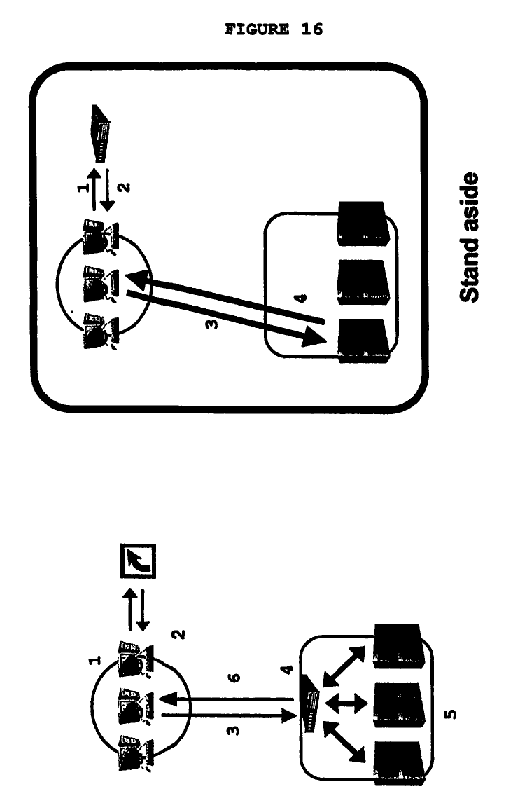

And because ITM solution of Stand aside type is used in order to simplify the network structure of each Edge, although the amount about instantaneous connection request increases, it can cope with instantaneous traffic congestion. That is, in a point of view of traffic management, if there is a query of a domain name, it replies through the optimal server IP address, and provides service according to service request. FIG. 16 is an exemplary view of ITM solution of a Stand aside type according to the present invention. An ITM solution like this type can solve the problem for increasing Edge server load despite of continuous increasing of traffic.

Because ITM solution according to this invention is independent of DNS, a manager can cope easily with an occurrence of serious fault as well as a falling-off in service quality.

In this invention, like Global Internet broadcasting service, even though a number of Origin servers and Edge servers are distributed on Internet, they can divide contents and synchronize with each other effectively.

And this invention provides a single management point for all works like traffic management, contents synchronization, clustering, contents distribution performed on a Global network and therefore has the effect reducing management cost.

Further because this invention applies a DRM technology about split files or distinguishes identification number of split files, it can protect on-line privacy and file that can be imperiled as a result of using a file exchange program widely.

What is claimed is:

1. A Streaming based contents distribution network system for implementing Multimedia File Playing using networks, said system comprising:
a splitter creating a file list and a header file about a plurality of UUID (Universally unique identifier)-type files by splitting a multimedia file having large capacity;
a merger restoring the multimedia files split by said splitter to an original file state when necessary;
an admin client having said splitter and said merger;
an original contents server receiving split files from said admin client and saving said files on a first internal database;
a CMS server installed in said original contents server detecting data creation, modification and deletion in real time;
a plurality of CAS servers receiving contents files and header files from said original contents server, the received files split from an original file by said splitter and saving said received files separately and said saved files being synchronized by said CMS server;
an IPMaster server managing Internet traffic of said system;
a CDMaster server synchronizing with a contents file saved on each of said CAS server by cooperating with said CMS server;
a CDMaster server synchronizing with contents files saved on each of said CAS servers by cooperating with said CMS server;
a plurality of SM Agents (Server Monitoring Agents) installed in each of said CAS servers, transmitting information for CPU, memory and session of a corresponding CAS server to said IPMaster server in real time so that if a client requests, said IPMaster server can select the optimal CAS server to the corresponding client and provides the requested contents from the corresponding CAS server;
a plurality of contents servers, each of them having a pair of said CAS server and said SM Agent;
a user-side Authentication Server performing authentication when a user logs in;
a Web server letting a client authenticated by said user-side Authentication Server connect to a web site constructed on Internet and access to a variety of contents;
a Primary Authentication Gateway Server having an authority to let a user access to contents saved on each contents server and checking whether each of said split contents files can be downloaded or not;
a Secondary Authentication Gateway Server realizing non-stop service by providing alternative routing for authentication in case of faults of said Primary Authentication Gateway Server;
an Authentication Proxy server installed in each of said Primary Authentication Gateway Server and said Secondary Authentication Proxy Server and sharing Authentication information among said Primary/Secondary Authentication Gateway Server and said user-side Authentication Server, and transmitting said Authentication information among said Primary/Secondary Authentication Gateway Server and said user-side Authentication Server; and
a dedicated client/player for said system getting authentication by requesting the authentication to said Primary Authentication Gateway Server in case that there are desired contents to download, and requesting the information about said desired contents to said IPMaster server to download said desired contents from an optimal contents server appointed by said IPMaster server and saving the downloaded information on a second internal database, and reproducing only the files saved on said second database according to a predefined schedule although all of said split files are not saved on said second database, and downloading the rest files while the reproduction is being made and saving the downloaded files on said second database so that the reproduction can be made continuously without a break.

2. A system as set forth in claim 1, wherein said system further comprises a DRM (Digital Rights Management) Encryption/Decryption Module in charge of copyright protection and management about said split and merged multimedia contents in encrypting each of said split files and in decrypting said merged file.

3. A system as set forth in claim 1, wherein a manager considers network traffic, state of network traffic and state of said system and makes it possible to split a desired file into files having a desired form and size and to transmit data without delay by using the most rapid method.

4. A system as set forth in claim 1, wherein said client/player downloads files to be reproduced in future from a plurality of contents servers saving the same contents through multi thread in parallel with the reproduction of downloaded files at the same time.

5. A system as set forth in claim 1, wherein said client/player is a multi-tasking system capable of parallel downloading of the split files by using a Multi-Thread and uses an ITM solution of a Stand-aside type, which makes it possible to download files continuously by comparing a file list of a Media-header part through normally operating servers even though a fault occurs in some servers among a plurality of contents servers.

6. A streaming contents distribution network system having an original contents server and a plurality of contents servers copying and saving the original contents, said system comprising:
an ENSplitter splitting a multimedia file to a plurality of UUID(Universally unique identifier) type files and creating a header file and saving the header file on a database of said original contents server and also performing file merging, encrypting and decrypting of said UUID files;
an ENSource participating in both a process of file split/mergence and a process of media reproduction and operation differently in each process and really splitting/merging media file and creating/analyzing a corresponding Header file, wherein said ENSource encrypts/decrypts UUID file and operates as a regular Direct Show Source Filter and transmits media data according to data requests of a Filter Graph and operates as a source plug-in DDL when reproducing Window media file and has UUID files and a table having information for positions and capacities of said UUID files;
an ENNetwork downloading a plurality of UUID files saved on a database in each contents server into a database of a Client side and saving on a Hard Disk of a client as a form of a Temporary File and managing the saved files, wherein at the same time if said ENSource requests a certain UUID file, said ENNetwork downloads or searches the file and then transmits a file handle (a Header file) to said ENSource and has a list of UUID files and a table saving a list of a Temporary file corresponding to the UUID files; and
an ENPlayer being a Direct Show Application and playing a role as a real Filter Graph and requesting data by using a clear description for its position and capacity to said ENSource through a Filter Graph Manager, and processing the transmitted data and reproducing media and having a play function of media files.

7. A system as set forth in claim 6, wherein said ENSplitter has a source file, an object file, a capacity of a file to be split, a Means of function selection, a Means of format selection and a Window where said Means of function selection has a split button and a mergence button, and said means of format selection has an AVI button, an MPEG button and a Window Media button and said system uses an ITM solution of a Stand-aside type.

8. A system as set forth in claims 6 or 7, wherein in encrypting said split files and in decrypting said merged file said system further comprises a DRM (Digital Rights Management) Encryption/Decryption Module in charge of copyright protection and management about said split and merged multimedia contents.

9. In a streaming contents distribution network system having an Original contents server saving original contents and a plurality of contents servers copying and saving said original contents for implementing Multimedia File Playing using a network, a method for splitting a multimedia file, transmitting and reproducing the transmitted files, said method comprising:
a step for splitting a multimedia file or merging multimedia files through a File Splitter;
a step for uploading said split or merged multimedia files to an Admin Server;
a step for copying said split contents files and a Header file to a database of a plurality of contents servers by using the Admin Server and synchronizing the contents;
a step for connecting to a Web server and selecting contents by a Client, wherein an Authentication Server of a user side performs authentication for a user ID, contents, completion time of contents and requests a billing process about an authenticated user to a Billing System Server and the Authentication Server of a user side requests authenticate information to the Authentication Proxy server and then the Authentication Proxy server transmits authenticate information to the Authentication Server of a user side;
a step for downloading Authentication Key and a Header File into a Client;
a step for requesting an optimal contents server to an IPMaster for downloading contents by a Client;
If an IPMaster selects the optimal contents server according to said request and notifies the selected result to the client, a step for requesting contents files to the corresponding contents server with an authentication Key by the Client, and requesting verification to a Primary Authentication Gateway Server whether authenticated or not by the contents server according to the user's request;
a step for downloading the requested file if said Primary Authentication Gateway Server makes the Authentication;
a step for saving downloaded file on a temporary storage as a temporary file by a client according to a schedule;
a step for reproducing said downloaded data by using a dedicated player; and
a step for deleting said temporary file saved on a temporary storage with the completion of the reproduction.

10. A method as set forth in claim 9, wherein in splitting of a file, said split file is encrypted by using a DRM Encryption/Decryption Module and said system uses an ITM solution of a Stand-aside type.

11. In a streaming contents distribution network system having an Original contents server saving original contents and a plurality of contents servers copying and saving said original contents for implementing Multimedia File Playing using a network, a method for splitting a multimedia file comprising:
a step for transmitting a Header file path to an ENSource by an ENSplitter that is a file splitter;
a step for operating a Filter Graph Manager by an ENSplitter so that an ENSource participates in connecting a Filter Graph;
if a Parser Filter requests data to the ENSource in said participating process, a step for transmitting the data requested by the Parser Filter existing in a Filter Graph and recording the particulars by an ENSource;
a step for splitting a media file based on the information of connection and split capacity by the ENSource if the ENSplitter gives a split order through an IENSource interface; and
a step for dynamically allotting UUID type files needed in said file split and performing encryption when necessary, wherein the ENSource arranges the UUID files and their tables for position and capacity after completion of the file split, and then creates a Header file.

12. A method as set forth in claim 11, wherein in splitting a file, said split files are encrypted by using a DRM Encryption/Decryption Module and said system uses an ITM solution of a Stand-aside type.

13. A method as set forth in claim 11, wherein in case that a corresponding source file is defined as connection information needed in structuring a filter graph, said method further comprises a step for performing said information analysis in order to complete file split perfectly and in this case x and y of (x, y) are indices for searching header information that denotes a position in a file and the position information 0 is a starting point of a header file.

14. A method as set forth in claim 13, wherein said method further comprises a step for arranging a plurality of small-sized file pieces created in file split on the basis of said connection information.

15. A method as set forth in claim 11, wherein said method further comprises a step for adding a parser filter and changing a protocol in accordance with a format for the format verification and the improvement of efficiency.

16. In a Streaming contents distribution network system for implementing Multimedia File Playing using a network, a file merging method for verifying whether a multimedia file was restored normally or not, wherein the multimedia file was split in the system and transmitted from the system, said method comprising:
a step for transmitting a Header file path to an ENSource through an IENSource interface of the ENSource by an ENSplitter, wherein the ENSplitter operates as a Merger and is a starting point for file merging in case merging UUID files;
a step for analyzing the Header file and restoring UUID files, their tables for position and capacity by the ENSource;
a step for requesting UUID files through an IENManager interface of an ENNetwork in accordance with the information recorded in a Header file by the ENSource;
a step for copying or downloading the UUID files which the ENSource requested and saving the downloaded files on a temporary storage and transmitting a corresponding file handle to the ENSource by the ENNetwork; and
a step for reading data through the file handle transmitted from the ENNetwork and performing file merging and restoring an original file by the ENSource, and in this case if a file is encrypted, merging process is performed after decryption of the file.

17. A reproduction method of a multimedia file that is split and transmitted in a Streaming contents distribution network system for implementing Multimedia File Playing using a network, said method comprising:
a step for making a Direct show application play a role as a main starting point when reproducing multimedia files, and operating in accordance with the request of a filter graph and transmitting a Header file path appointed by the Direct show application to an IfileSourceFillter interface of an ENSource through a filter graph manager;
a step for analyzing the Header file and restoring UUID files and their tables for position and capacity by the ENSource;
a step for requesting data needed in connection and reproduction to the ENSource in sequence by filter graph and at this time transmitting the information specifying the data position and capacity of a desired file;
a step for finding UUID files in accordance with the information recorded in a Header file about the data requested by a filter graph and requesting the file through an IENManager interface of an ENNetwork by the ENSource;
a step for copying or downloading a UUID file which the ENSource requests and saving the copied or downloaded file on a temporary storage and transmitting a corresponding file handle to the ENSource by the ENNetwork; and
a step for reading data through a file handle transmitted from the ENNetwork and transmitting the read data to a filter graph and in this case if a file is encrypted, performing decryption by the ENSource.
